(19) United States
(12) Patent Application Publication
(10) Pub. No.: US 2026/0026990 A1
(43) Pub. Date: Jan. 29, 2026

(54) HEADREST AND MASSAGE TABLE

(71) Applicant: Tyler Warren, Pittsford, NY (US)

(72) Inventor: Tyler Warren, Pittsford, NY (US)

(21) Appl. No.: 19/280,422

(22) Filed: Jul. 25, 2025

Related U.S. Application Data
(60) Provisional application No. 63/675,503, filed on Jul. 25, 2024.

(51) Int. Cl. A61G 13/12; A61G 13/00; A61G 13/10

(52) U.S. Cl. CPC A61G 13/121; A61G 13/009; A61G 13/101

(57) ABSTRACT

The improvement of a headrest used with a massage table to allow more effective Treatment. The adjustability provided by the new headrest allows more focused treatment of patient by allowing increased access to the patient's neck. The headrest can be adjusted to each patient and their treatment requirements.

### CROSS REFERENCE TO RELATED APPLICATION[S]

This application claims priority to U.S. Provisional Patent Application entitled “HEADREST AND MASSAGE TABLE,” Ser. No. 63/675,503, filed Jul. 25, 2024, the disclosure of which is hereby incorporated entirely herein by reference.

### BACKGROUND OF THE INVENTION

It is typical practice that massage therapists use tables in providing massages to clients. A typical table is flat with an adjustable bottom and top portion and typically has an extension that serves as a head support so that massage therapy can be directed to various portions of the patient's body. Massage tables have a headrest that is a horseshoe shaped fixture with a solid base and a cushioned surface on the top, which is also in the general shape of a horseshoe. The open end of the horseshoe is open at the end facing the body.

The state-of-the-art headrest has limited adjustability typically along an obtuse angle to the center of the board. The state-of-the-art headrest is not designed or allows for adjustment other than height. The headrest can be extended as well as raised and lowered to fit the specific patient.

### BRIEF DESCRIPTION OF THE FIGURES

FIG. 1 illustrates a state of the art collapsible of a massage bed/platform 1 with a two part body platform 2, a headrest with a u-shaped headrest with the opening open towards the platform, 6, adjustable legs, 4, and brace arms 5.

FIG. 2 is a second state of the art massage table 7 that has a head rest 8, and solid padded table top and four solid legs 10.

FIG. 3 illustrates an embodiment of the present invention 11 with a U-shaped headrest 12 with an open portion of the headrest positioned away from the table top of a typical massage table. The headrest also has a first 13 and second rod 14 for attachment to a massage table. A cross member 15 spans the rods to join the rods and provide a ball joint mechanism 17 that allows a rod 16 to support the headrest.

FIG. 4 shows a mount system 18 that allows adjustment of height and angle of the headrest with a first lockable joint 19 and height2 and a second lockable joint 20 of a headrest 21.

FIG. 5 illustrated another embodiment of the invention with s headrest 22 a section 23 connects with a single plane swivel joint 24 and a connection means with a massage table.

FIG. 6 shows an embodiment 26 of the novel headrest with a left portion 27 and a right portion 28 and a connection means 29 joining the two portions and allowing adjustment of the distance between the two headrest portion. The connection means an adjustable portion connecting the two mounts has a slidable or threaded means to control the distance between the two headrest portions.

FIG. 7 illustrates another embodiment of the invention that has a connections means 32 for the headrest with an in plane adjustment 33 for side to side to side adjustment through a single point of rotation in the horizonal plane 34.

FIG. 8 Shows a form of the headrest support with areas that can be varied in hardness or height or shape or function, such as temperature or having a vibration state. These are 34A, 34B, 34CC and 34D

FIG. 9 shows a headrest embodiment 35 with a simple single axis of rotation mounting tube 36.

FIG. 10 is an embodiment 37 of the mounting hardware showing a ball joint system providing adjustment of the headrest 38.

FIG. 11 shows an embodiment 39 with tow adjustment joints providing separate levels of adjustment 40 and 41.

### DETAILED DESCRIPTION OF EMBODIMENTS OF THE INVENTION

The invention relates to a novel headrest that can be used with massage tables to provide the ability expose portions of a patients neck to more effective massage. The novel and useful headrest starts with a u-shaped headrest that is passed and configures to a patients face and decreases the pressure on a patients sinus passages. Along with allowing greater adjustability more of the patient's neck is exposed for a massage therapist to work. The specific portion of the neck can be exposed to allow the therapist to apply pressure from above the target portion of the patient.

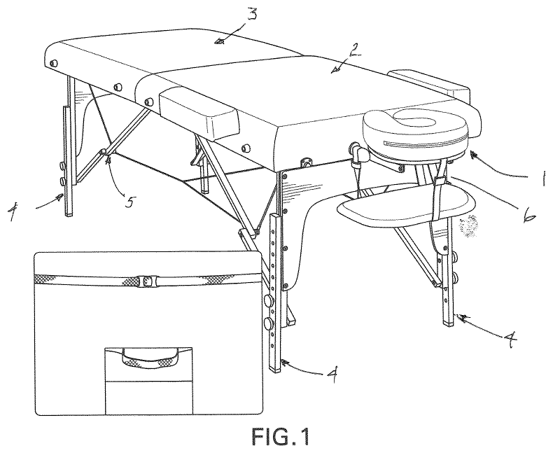

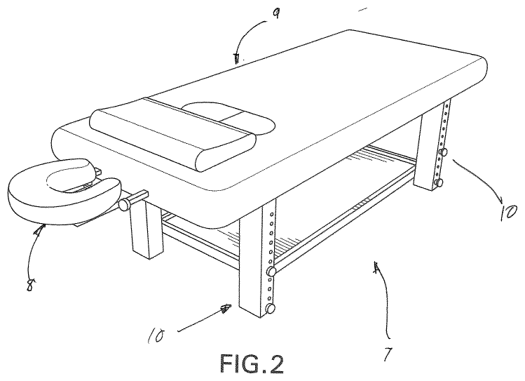

The U-shaped headrest has the open portion of the U-headrest away from the patient's body. The headrest portion is a base that is connected to a support mechanism that links to a massage table. Ther state of the art in headrest align the headrest, if it is U-shaped with it's open faced towards the table. This is shown in FIGS. 1 and 2. Typically the headrest is attached to the table with two parallel sliding fixtures and allows adjustment to correspond with the height of the patient. This adjustment provides no range of adjustment for the orientation of the patients head and spine relative to the top of the table.

Massage therapy requires the therapist to expend energy to manipulate tissue, and the ability to be able to directly target the portion of the clint's tissue allows the therapist to use gravity. So a headrest that allows the patient to be more comfortable due to less pressure on the patients sinus, and further allows the patient's head and neck to be further exposed by adjusting the position and angle of the patient's head and neck.

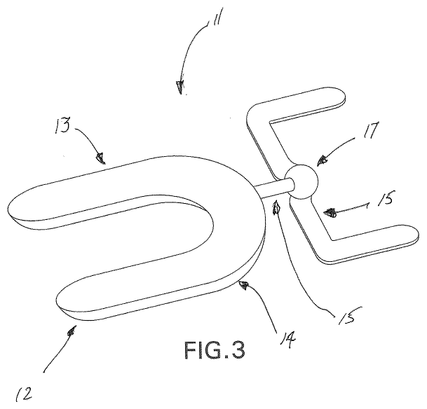

FIG. 3 Illustrates an embodiment of the present invention 11 with a U-shaped headrest 12 with an open portion of the headrest positioned away from the table top of a typical massage table. The headrest also has a first 13 and second rod 14 for attachment to a massage table. A cross member 15 spans the rods to join the rods and provide a ball joint mechanism 17 that allows a rod 16 to support the headrest. Specifically the two rods that are capable of fitting with a state of the art bed in order to retrofit to an existing state of the art bed. The ball joint is lockable so it can be configured to alter the vertical height of the headrest, and allow the headrest to be rotated about the plane of the table top of the table.

The rotation allows the left and right portions of the headrest to slant either to the left or right. This rotation allows exposure of a portion of patients neck. The single rod connecting the head rest to the ball joint also allows greater access to the patient's neck.

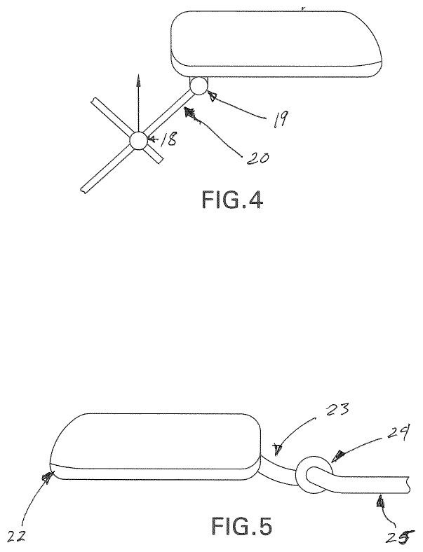

Continuing the concept of greater exposure and additional adjustment of the patient's head FIG. 4 shows a mount system 18 that allows adjustment of height and angle of the headrest with a first lockable joint 19 and height2 and a second lockable joint 20 of a headrest 21. The headrest need not be in the form of a U shaped headrest and an alternative headrest which may include further shapes than the state of the art headrests. This concept is further exemplified in FIG. 5. Which illustrates another embodiment of the invention with s headrest 22 a section 23 connects with a single plane swivel joint 24 and a connection means with a massage table.

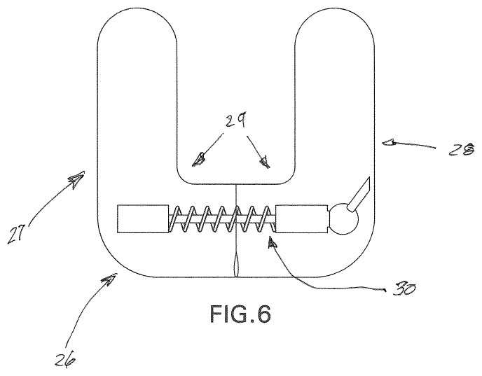

FIG. 6 shows an embodiment 26 of the novel headrest with a left portion 27 and a right portion 28 and a connection means 29 joining the two portions and allowing adjustment of the distance between the two headrest support portions. The connection means an adjustable portion connecting the two mounts has a slidable or threaded means to control the distance between the two headrest portions. This allows adjustment of the effective width of the headrest to allow for variation is size between patients. This adjustment allows greater comfort of the patient in a specific orientation.

Specific massage treatments are directed to neck pain, and the increased comfort allows longer and better focused treatments for a patient. Creating adjustability of a headrest provides this increased comfort. There are numerous mechanisms that allow for rid length projections know in the art, any of which would be useful in the present invention besides the specific mechanism disclosed here.

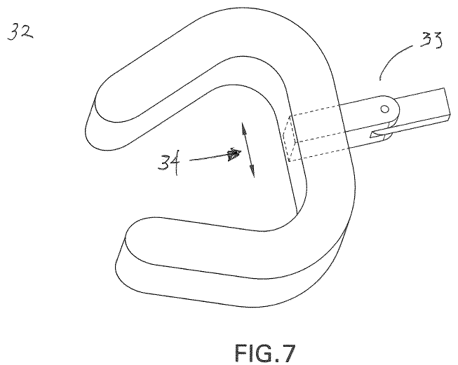

Further alteration of adjustment of the angle of the headrest relative to the linear axis of the patient's spine is show in FIG. 7 that has a connections means 32 for the headrest with an in plane adjustment 33 for side to side to side adjustment through a single point of rotation in the horizonal plane 34 of the massage table plane and the corresponding axis of the patient's spine.

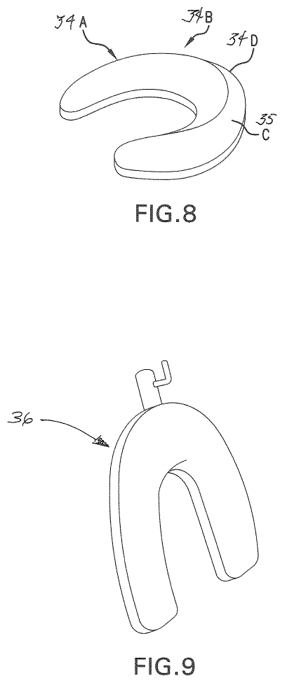

An alternative headrest as shown in FIG. 8. Thoi form shows a headrest support with areas that can be varied in hardness or height or function, such as temperature or having a vibration state. These are 34A, 34B, 34CC and 34D. The concept of adding further features

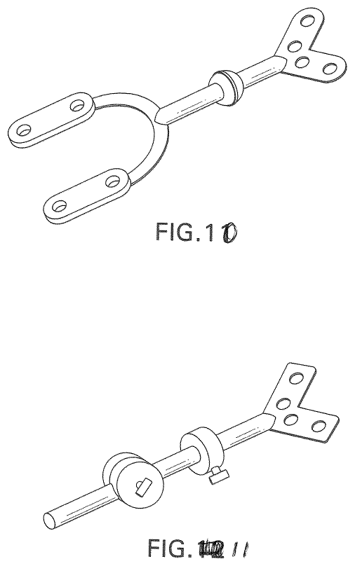

FIG. 9 shows a headrest embodiment 35 with a simple single axis of rotation mounting tube 36. FIG. 10 is an embodiment 37 of the mounting hardware showing a ball joint system providing adjustment of the headrest 38. FIG. 11 shows an embodiment 39 with tow adjustment joints providing separate levels of adjustment 40 and 41. Other embodiments may be made according to the specification by people skilled in the art.

The cushion rests along the top of the head, along the face, and is in contact with the clients' face. This pressure can cause compression of a client's sinuses and disrupt comfortable breathing. The limited range of adjustments also reduces access by the therapist to the cervical spine. A headrest that decreases pressure to the facial surfaces next to sinuses and which can allow positioning of the head in a range of positions to provide access to the neck would be of great advantage. A lightweight system that is attachable to a fixed massage table or a mobile table would be useful as well.

The attachment hardware for the system allows adjustment for height, for swiveling the headrest left or right, and adjustment off the main axis of the table.

As can be seen in FIG. 1, a massage table is generally a four-legged table sturdy enough to hold a patient and the partial weight of the massage therapist. FIG. 1 shows a portable table that folds up flat and can be placed in a carrying bag.

The table as shown has two portions to support the patient's body and two adjustable armrests. The headrest shown has two extension bars going to the padded u-shaped headrest. Other massage tables are similarly configured. FIG. 2 shows a massage table without a headrest extension.

In cases with all of the headrests in the state of the art the opening is closest to the main table surface. The headrest has a single range of adjustment.

The present invention provides a mounting system with three degrees of adjustment. Extension from the top of the table to accommodate the length of the particular patient. This can be produced in at least two forms. Dual extension arms with a cross-member and an effective ball joint with an extension member to the frame of the headrest. The extension member allows for up and down, or higher and lower elevation and rotation of the headrest assembly to allow tilt of the head rest, as shown in FIG. 3.

A second suspension apparatus has a single axis extension connected through a ball joint to a 360-degree lockable swivel and connects slidably to the massage table at the other end.

A third form of the head extension also has a pivot link between the apparatus swivels to the left and right as shown in FIG. 4. This mounting apparatus retrofits many massage tables/

As shown in FIG. 3, the improvement in the novel headrest has several variations and modifications over the state of the art. The first is the orientation of the supporting cushion so that the top of the patient's head is away from the table. This allows less compression of a patient's sinuses and eases supported access to the neck in cooperation with the support mechanism for the support cushion.

At least three separate forms of support apparatus or hardware exist starting with a mechanism comprising two parallel rails that fit into the hardware of existing massage tables, where a cross bar joins the two rails, and a further rail extends from the cross bar to the head support cushion. Extension distance of the headrest to the table is adjusted through extension of the two parallel rails and positioning of the headrest is controlled by the third rail along a lockable pivot of the crossbar.

Further rotation of the headrest out of level, which allows varying access to the patient's neck, can be set by a lockable swivel joint on the support of the headrest cushion assembly. When turned face up throughout the session, the patient's head does not need to come out of the headrest as the headrest can now be adjusted. After adjustments are made to the headrest, there is now room for the therapist to slide their arms underneath to work the head, neck, shoulders, and Décolleté. This would be impossible for normal headrests as they all have posts in the way for support of the face cradle

The second variation again includes a crossbar within the headrest that allows adjustment of the distance between the two sides of the headrest cushion to fit the width of the patient's head. This can be made into a third version of the mounting apparatus.

The last variation also has two mounting rails but with a crossmember mounted nearer the table with a ball joint that is lockable and a single rail that attaches to the support base of the headrest cushion.

The cushion is made of three layers, a hardened two-part base with a level to allow for adjustment of the two sides in width and relative planarity, a hinge like adjustment that allows for more firm cradling of the patient's head, and on top of the mounting plates and mechanical adjustments is at least one layer of cushion material.

By having adjustability of the rotation of the headrest cushion a patient can be oriented in different ways to allow greater access exposing different body portions to treatment. For instance, a patient's head can be rotated exposing a targeted portion of the neck to be worked on. The support can be easily adjusted to allow for various supported positions not limited to head position. A patient may be positioned on their side with the head rest adjusted upward to support the head and neck in a relaxed and supported position.

The mounting apparatus for the novel cushion head support has several important features novel to massage headrest art. There is adjustability of the headrest around the axis of the headrest along its main support extending from the head of the massage table to the closed end of the headrest nearest the massage table. the axial support extends from the head of the massage table to the headrest. The second degree of adjustability is to alter the angle of the headrest to the axial support. Both forms of adjustability can be accomplished through a lockable ball joint that can change either the angle of the headrest to the massage table or change the angle of the headrest to the axis of the main support.

The novel headrest is generally u shaped as shown in the figures, where the U has an opening. The opening is positioned away from the massage table. The headrest comprises a solid support that serves as a base for the headrest and allows the supporting apparatus to attach. A suctioned portion sits on the base serving as a support for the patient's head and is affixed to the base. This cushion comprises at least one portion, or in the instance where the base itself may be adjustable, the cushion may have at least two segments.

The headrest itself can be adjustable to conform to a specific patient. Since the size of each patient may vary, the width and depth of the u-shape may be varied by adjustment. The width of the u-shape can be adjusted by providing the base with two portions that are adjustably attached to allow the u shape to be broadened or narrowed.

1. A headrest apparatus for attachment to a massage table comprising:
a U-shaped headrest;
a support mechanism attached to said U-shaped headrest;
an attachment mechanism attaching said support mechanism to a massage table,
wherein said U-shaped headrest is disposed to have its open end portion away from said massage table and support mechanism movably connects to said attachment mechanism and attachment mechanism is retrofittable to a state of the art massage table.

2. The headrest apparatus of claim 1 wherein said support mechanism:
a. A first support attachment piece and a second support attachment that are attachable to a massage table;
b. A cross-member joining said first attachment piece and said second attachment piece;
c. A ball joint on said cross-member;
Wherein said ball joint attaches to said support mechanism.

3. The hardest apparatus of claim 1 where said headrest further comprises;
A cushion as part of the headrest conforming to the U-shape of said headrest;
at least two adjustable portions.

4. The headrest of claim 1 further wherein said headrest comprises a left and right portion and a slidable connecting section.

5. The headrest of claim 4 where the slidable connecting sections allows the adjustment of the width of the U shaped headrest.

6. A massage table comprising:
i. a massage table with a padded table top;
ii. a headrest apparatus with A U-shaped headrest;
iii. A support mechanism attached to said U-shaped headrest;
iv. An attachment mechanism attaching said support mechanism to a massage table,
Wherein said U-shaped headrest is disposed to have its open end portion away from said massage table and support mechanism movably connects to said attachment mechanism and attachment mechanism is retrofittable to a state of the art massage table.

7. A massage table comprising: a padded tabletop surface;
Four support legs; and a headrest
A U-shaped headrest;
A support mechanism attached to said U-shaped headrest;
An attachment mechanism attaching said support mechanism to a massage table A U-shaped headrest;
A support mechanism attached to said U-shaped headrest;
An attachment mechanism attaching said support mechanism to a massage table,
Wherein said U-shaped headrest is disposed to have its open end portion away from said massage table and support mechanism movably connects to said attachment mechanism and attachment mechanism is retrofittable to a state of the art massage table wherein said U-shaped headrest is disposed to have its open end portion away from said massage table and support mechanism movably connects to said attachment mechanism and attachment mechanism is retrofittable to a state of the art massage table wherein said headrest are connectable.

8. A massage table comprising: a
i. padded tabletop surface;
ii. Four support legs; and
iii. headrest according to claim 3 wherein said headrest are connectable. A U-shaped headrest;
iv. A support mechanism attached to said U-shaped headrest
v. An attachment mechanism attaching said support mechanism to a massage table,
Wherein said U-shaped headrest is disposed to have its open end portion away from said massage table and support mechanism movably connects to said attachment mechanism and attachment mechanism is retrofittable to a state of the art massage table.

9. A massage table comprising: a padded tabletop surface;
i. Four support legs;
ii. wherein said headrest comprises a left and right portion and a slidable connecting section. and said U-shaped headrest is disposed to have its open end portion away from said massage table and support mechanism movably connects to said attachment mechanism.

10. A massage table comprising:
i. a padded tabletop surface;
ii. four support legs; and a headrest where the slidable connecting sections allows the adjustment of the width of the U shaped headrest.
